(19) United States
(12) Patent Application Publication
(10) Pub. No.: US 2025/0033882 A1
(43) Pub. Date: Jan. 30, 2025

(54) SCISSOR-TYPE TELESCOPIC APPARATUS AND AUTOMATIC FOOD VENDING MACHINE

(71) Applicant: SHENZHEN CHAOYONG TIMES TECHNOLOGY CO., LTD., Shenzhen (CN)

(72) Inventor: Hengjie ZHANG, Shenzhen (CN)

(73) Assignee: SHENZHEN CHAOYONG TIMES TECHNOLOGY CO., LTD., Shenzhen (CN)

(21) Appl. No.: 18/918,428

(22) Filed: Oct. 17, 2024

Related U.S. Application Data
(63) Continuation of application No. PCT/CN2023/093462, filed on May 11, 2023.

(30) Foreign Application Priority Data
May 23, 2022 (CN) 202221250432.4

(51) Int. Cl. B65G 1/06; B66F 7/06

(52) U.S. Cl. CPC B65G 1/06; B66F 7/0608; B66F 7/0666

(57) ABSTRACT

Disclosed are a scissor-type telescopic apparatus and an automatic food vending machine. The scissor-type telescopic apparatus includes a base seat; a bidirectional lead screw including a right-hand thread portion and a left-hand thread portion; two lead screw nuts respectively threaded with the right-hand thread portion and the left-hand thread portion of the bidirectional lead screw, so as to move relatively away or relatively close in response to that the bidirectional lead screw is rotated; a first telescopic unit including two first scissor arms, ends of the two first scissor arms away from the base seat are both provided with gears, and the two gears are meshed; and a telescopic apparatus head respectively hinged with the ends of the two first scissor arms away from the base seat.

### CROSS-REFERENCE TO RELATED APPLICATIONS

The present application is a continuation application of International Application No. PCT/CN2023/093462, filed on May 11, 2023, which claims priority to Chinese Patent Application No. 202221250432.4, filed on May 23, 2022. The disclosures of the above-mentioned applications are incorporated herein by reference in their entireties.

### TECHNICAL FIELD

The present application relates to the technical field of vending machines, and in particular to a scissor-type telescopic apparatus and an automatic food vending machine.

### BACKGROUND

With the acceleration of the life pace, automatic food vending machines have emerged. In traditional automatic food vending machines, the food pushing mechanism mostly adopts a crawler and a push plate method. In this case, the receiving end also needs a crawler or a similar mechanism to cooperate, and the food can be taken out to the receiving end by pushing and pulling. Some automatic food vending machines also use a manipulator to complete the food delivery operation. The food delivery structures of these automatic food vending machines are very complicated and costly. If the food is pushed by a telescopic pushing rod, not only is the structure simple, but the food can be pushed to the specified position accurately. However, the general sleeve-type telescopic pushing rod requires a large installation distance, but the telescopic distance is small, which is not suitable for automatic food vending machines.

### SUMMARY

The main purpose of the present application is to provide a scissor-type telescopic apparatus, aiming to achieve a short installation distance and a long telescopic distance of the scissor-type telescopic apparatus.

To achieve the above purpose, the present application provides a scissor-type telescopic apparatus, including
a base seat;
a bidirectional lead screw including a right-hand thread portion and a left-hand thread portion, and two ends of the bidirectional lead screw are rotatably connected to opposite two sides of the base seat;
two lead screw nuts respectively threaded with the right-hand thread portion and the left-hand thread portion of the bidirectional lead screw, so as to move relatively away or relatively close in response to that the bidirectional lead screw is rotated;
a first telescopic unit including two first scissor arms, ends of the two first scissor arms away from the base seat are both provided with gears, and the two gears are meshed; and
a telescopic apparatus head respectively hinged with the ends of the two first scissor arms away from the base seat, so as to drive the telescopic apparatus head to move close to or away from the base seat in response to that the telescopic unit is extended or retracted.

In an embodiment, the base seat is enclosed to form an accommodation groove, and two opposite side walls of the accommodation groove are provided with shaft holes;
the ends of the bidirectional lead screws are rotatably inserted into the shaft holes, and the other two opposite side walls of the accommodation groove are provided with guiding grooves, and
two ends of the two lead screw nuts are respectively slidably inserted into the two guiding grooves.

In an embodiment, the scissor-type telescopic apparatus further includes:
a second telescopic unit;
and the second telescopic unit includes two second scissor arms, and middle parts of the two second scissor arms are hinged to form an X-shaped scissor structure; and
two ends of the two second scissor arms close to the base seat are respectively hinged to the two lead screw nuts.

In an embodiment, one, two or more second telescopic units are provided, and the two or more scissor arms of the second telescopic units are hinged in sequence in a telescopic direction of the scissor-type telescopic apparatus; and
two ends of the first telescopic unit on one side close to the base seat are respectively hinged with two ends of the second telescopic unit farthest from the base seat on one side away from the base seat.

In an embodiment, one, two or more groups of the first telescopic units and the second telescopic units are provided, and the two or more groups of the first telescopic units and the second telescopic units are provided in parallel and spaced apart.

In an embodiment, the lead screw nut further includes a sliding rod slidably provided in the guiding groove.

In an embodiment, the lead screw nut further includes a connecting portion, and an end of the second telescopic unit is hinged to the connecting portion or rotatably connected to the sliding rod of the lead screw nut.

In an embodiment, a shape of one end of the telescopic apparatus head away from the base seat is flat or bent.

The present application also provides an automatic food vending machine, including:
a machine shell enclosed to form an accommodation chamber and provided with a food delivery port;
a food storage rack provided in the accommodation chamber and provided with a plurality of storage spaces; and
a food collection assembly including a food storage member and a food pushing member, the food storage member is movably provided in the food storage rack, and the food pushing member is movably provided on a periphery side of the food storage rack to push the food in the storage space to the food storage member or the food delivery port;
and the telescopic apparatus of the food pushing member is the scissor-type telescopic apparatus.

In an embodiment, the automatic food vending machine further includes:
a heating component;
a food delivery box; and
a food delivery transfer apparatus;
the heating component is provided above the food storage rack;
the food delivery box is adjacent to the food delivery port; and
the food delivery transfer apparatus is movably provided between the heating component and the food delivery box.

In an embodiment, the food delivery transfer apparatus includes a bracket and a lifting box, and the lifting box includes a frame body and a movable bottom plate;
the frame body and the movable bottom plate are enclosed to form a storage chamber, and one side of the frame body is a fixed opening configured to allow the food of the food collection assembly to enter the storage chamber; and
the movable bottom plate is movably connected to a bottom surface of the frame body to open or close the bottom surface of the lifting box.

In an embodiment, the food delivery transfer apparatus further includes a driving assembly, and the driving assembly includes a driving member a bidirectional lead screw and a lead screw slider; and
the bidirectional lead screw is configured to drive side rods on both sides of the lifting box to move in opposite directions, so as to drive a bottom rod of the movable bottom plate to move in opposite directions to open or close the bottom surface of the lifting box.

The technical solution of the present application is to provide a scissor-type telescopic apparatus, including a base seat, a bidirectional lead screw, two lead screw nuts, a first telescopic unit and a telescopic apparatus head. The two ends of the bidirectional lead screw are rotatably connected to the opposite sides of the base seat to drive the lead screw nut to move. The two lead screw nuts are respectively threaded with the two ends of the bidirectional lead screw to move away from or relatively close to each other when the bidirectional lead screw rotates. The first telescopic unit includes two first scissor arms, and the ends of the two first scissor arms away from the lead screw nut are respectively provided with a gear, and the two gears are meshed to ensure the stability of the telescopic apparatus head. The telescopic apparatus head is hinged to the ends of the two first scissor arms close to the gears, so that when the two ends of the two first scissor arms are close to or away from each other, the telescopic apparatus head is driven to move close to or away from the base seat. The scissor-type telescopic apparatus of the present application drives the scissor telescopic bracket to be extended and retracted through the bidirectional lead screw, thereby meeting the use requirements of small installation distance and large telescopic distance.

### BRIEF DESCRIPTION OF THE DRAWINGS

FIG. 1 is a schematic structural view of a scissor-type telescopic apparatus according to an embodiment of the present application.

FIG. 2 is a schematic structural view of the scissor-type telescopic apparatus according to another embodiment of the present application.

FIG. 3 is an exploded view of FIG. 1.

FIG. 4 is a schematic structural view of an automatic food vending machine according to an embodiment of the present application.

FIG. 5 is a schematic structural view of a food delivery transfer apparatus in FIG. 4.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that all directional indications (such as up, down, left, right, front, back, etc.) in the embodiments of the present application are only used to explain the relative positional relationship, the movement situation, etc. If the specific posture changes, the directional indication also changes accordingly.

In addition, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

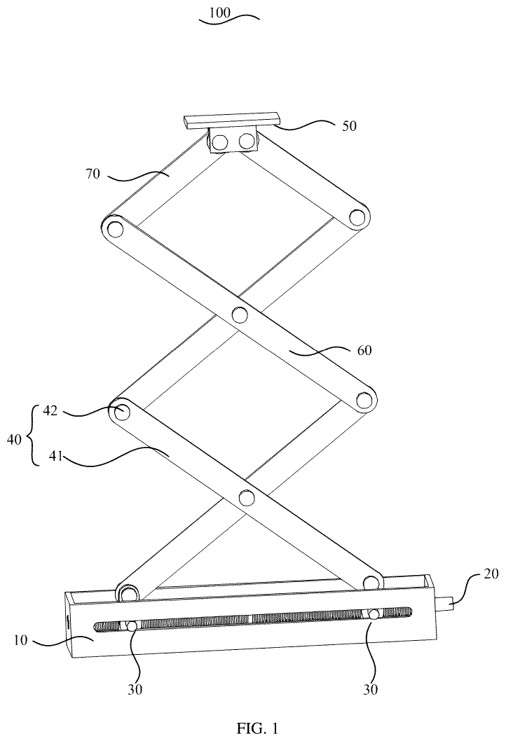

With reference to FIG. 1 to FIG. 3, the scissor-type telescopic apparatus 100 provided in the present application includes a base seat 10, a bidirectional lead screw 20, two lead screw nuts 30, a first telescopic unit 70, and a telescopic apparatus head 50. The bidirectional lead screw 20 includes a right-hand threads portion 21 and a left-hand threads portion 22, and both ends of the bidirectional lead screw 20 are rotatably connected to opposite sides of the base seat 10. The two lead screw nuts 30 are respectively threaded with the right-hand threads portion 21 and the left-hand threads portion 22 of the bidirectional lead screw 20, so as to move relatively away from or relatively close to each other when the bidirectional lead screw 20 rotates. The first telescopic unit 70 includes two first scissor arms 71. The ends of the two first scissor arms 71 away from the base seat 10 are both provided with gears 72, and the two gears 72 are meshed. The telescopic apparatus head 50 is respectively hinged to the ends of the two first scissor arms 71 on the side away from the base seat 10, so as to drive the telescopic apparatus head 50 to move close to or away from the base seat 10 when the telescopic unit is extended and retracted.

In an embodiment shown in FIG. 1, the base seat 10 is a rectangular cuboid. The bidirectional lead screw 20 is inserted through the rectangular cuboid base seat 10, and is firmly connected and can smoothly rotate on the two inserted walls. The two lead screw nuts 30 are provided on the left and right of the bidirectional lead screw 20 and are threaded with the bidirectional lead screw 20. When the bidirectional lead screw 20 rotates, the two lead screw nuts 30 are driven to move in opposite directions or opposite directions, so as to serve as the power for the scissor-type telescopic apparatus 100 to perform telescopic movement.

The first telescopic unit 70 includes two first scissor arms 71. Compared with the telescopic scissor arm 41 in the second telescopic unit 40, the first scissor arm 71 is shorter and is only provided through holes at both ends. At the connection between the first scissor arm 71 and the telescopic apparatus head 50, the ends of the two first scissor arms 71 away from the base seat 10 are provided with gears 72. The gears 72 are engaged with each other to ensure that the telescopic apparatus head 50 will not deviate to one side due to force, so as to remain stable.

The telescopic apparatus head 50 and the second telescopic unit 40 can also be fixed by connecting shaft 42, which is convenient to assemble and firmly connected. The telescopic apparatus head 50 can be designed to be larger than the base seat 10, or to be the same size as the base seat 10, or to be smaller than the base seat 10, so as to adapt to different usage scenarios.

The present application technical solution provides a scissor-type telescopic apparatus 100, including a base seat 10, a bidirectional lead screw 20, two lead screw nuts 30, a first telescopic unit 70 and a telescopic apparatus head 50. The base seat 10 encloses to form an accommodation groove, and two opposite side walls of the accommodation groove are provided with shaft holes 12 for installing the bidirectional lead screw 20. Two ends of the bidirectional lead screw 20 pass through the shaft holes 12 and are hinged to the opposite sides of the base seat 10. The two lead screw nuts 30 are respectively threaded with the two ends of the bidirectional lead screw 20, so as to move relatively away from or relatively close to each other when the bidirectional lead screw 20 rotates. The first telescopic unit 70 includes two first scissor arms 71, and one end of the two first scissor arms 71 on the same side is respectively connected to the end of the telescopic scissor arm 41 away from the lead screw nut 30. The ends of the two first scissor arms 71 away from the telescopic scissor arm 41 are respectively provided with a gear 72, and the two gears 72 are meshed. The telescopic apparatus head 50 is hinged to the ends of the two first scissor arms close to the gear 72, so that when the two ends of the two first scissor arms 71 are close to or away from each other, and the telescopic apparatus head 50 is driven to move close to or away from the base seat 10. The scissor-type telescopic apparatus 100 of the present application combines the bidirectional lead screw 20 with the scissor telescopic bracket, and the bidirectional lead screw 20 drives the two scissor arms to move and retract at the same time, thereby increasing the telescopic distance of the telescopic apparatus, realizing the miniaturization of the scissor-type telescopic apparatus 100, and meeting the use requirements of small installation space and large telescopic distance.

In an embodiment, the base seat 10 encloses to form an accommodation groove, and shaft holes 12 are provided on opposite side walls of the accommodation groove. The ends of the bidirectional lead screw 20 can be rotatably inserted into the shaft holes 12. Guiding grooves 11 are provided on the other opposite side walls of the accommodation groove, and the two ends of the two nuts are respectively slidably inserted into the two guiding grooves 11.

In this embodiment, side walls formed by the width and height of the rectangular cuboid base seat 10 are provided with shaft holes 12, so as to fix the right-hand thread and left-hand thread screw rod, which is convenient to process. The bidirectional lead screw 20 is provided with right-hand threads portion 21 and left-hand threads portion 22 from the middle to both sides, and the threads on the right-hand threads portion 21 and the left-hand threads portion 22 are opposite in direction. When the bidirectional lead screw 20 rotates towards one side, the threads of the right-hand threads portion 21 and the left-hand threads portion 22 rotate in opposite direction, and the threaded lead screw nut 30 performs a symmetrical motion. In this embodiment, the end of the bidirectional lead screw 20 is the port with the driving apparatus, which is simple and convenient. In other embodiments, and the port can be in the middle of the bidirectional lead screw 20 to increase the stability of the rotation of the bidirectional lead screw 20.

The side surface surrounded by the length and height of the rectangular base seat 10 can protect the bidirectional lead screw 20 from external impact. In addition, the guiding groove 11 is opened on the two side walls, and the direction of the guiding groove 11 is parallel to the bidirectional lead screw 20. The two ends of the lead screw nut 30 are passed through the guiding groove 11, which can not only stably fix the lead screw nut 30 to prevent it from rotating around the axis driven by the bidirectional lead screw 20, but also limit the translation of the lead screw nut 30 to prevent the movement directions of the two lead screw nuts 30 from being inconsistent, which may otherwise reduce the telescopic effect. The guiding groove 11 on one side wall can be one line. When the rotating shaft for transmission is in the middle of the bidirectional lead screw 20, the guiding groove 11 can be two sections, facing the right-hand threads portion 21 and the left-hand threads portion 22 respectively, and guiding and limiting the lead screw nut 30 on the right-hand threads portion 21 and the left-hand threads portion 22.

In an embodiment, the scissor-type telescopic apparatus 100 also includes a second telescopic unit 40, and the second telescopic unit 40 includes two second scissor arms. The middle parts of the two second scissor arms are hinged to form an X-shaped scissor structure, and the two ends of the two second scissor arms close to the base seat 10 are respectively hinged to the two lead screw nuts 30.

With reference to FIG. 1, the minimum structure of the second telescopic unit 40 includes two telescopic scissor arms 41. A connecting shaft 42 is inserted in the middle of the two telescopic scissor arms 41 to form the X-shaped scissor structure, and same sides of the two telescopic scissor arms 41 are respectively connected to the lead screw nut 30 and the telescopic apparatus head 50.

The second telescopic unit 40 includes at least two telescopic scissor arms 41 and a connecting shaft 42, and through holes are provided in the middle and both ends of the telescopic scissor arm 41. The connecting shaft 42 is inserted in the middle of the two telescopic scissor arms 41, and the two telescopic scissor arms 41 can rotate around the connecting shaft 42. The lower ends of the two telescopic scissor arms 41 are connected to the lead screw nut 30. When the lead screw nuts 30 move relative to each other, the two telescopic scissor arms 41 also move relatively close to or relatively far away from each other, and the height of the second telescopic unit 40 increases or decreases accordingly, achieving the effect of extension and contraction.

In an embodiment, the number of the second telescopic unit 40 can be one, two or more, and the scissor arms of the two or more second telescopic units 40 are hinged in sequence in the telescopic direction of the scissor-type telescopic apparatus 100. The two ends of the first telescopic unit 70 close to the base seat 10 are respectively hinged with the two ends of the second telescopic unit 40 farthest from the base seat 10 and away from the base seat 10;

And/or, one two or more groups of the first telescopic unit 70 and the second telescopic unit 40 are provided, and the two or more groups of the first telescopic unit 70 and the second telescopic unit 40 are provided at intervals in the axial direction of the lead screw nut 30.

In the case of long-distance use, it is necessary to assemble multiple second telescopic units 40 with the smallest structure. From down to up, the ends of the multiple second telescopic units 40 with the smallest structure are aligned, and the connecting shaft 42 is inserted, so that the arm span of the second telescopic unit 40 is increased, and the telescopic distance is also increased. In this embodiment, two pairs of telescopic scissor arms 41 are used. In other embodiments, the number of pairs of telescopic scissor arms 41 can be three, four, five, etc.

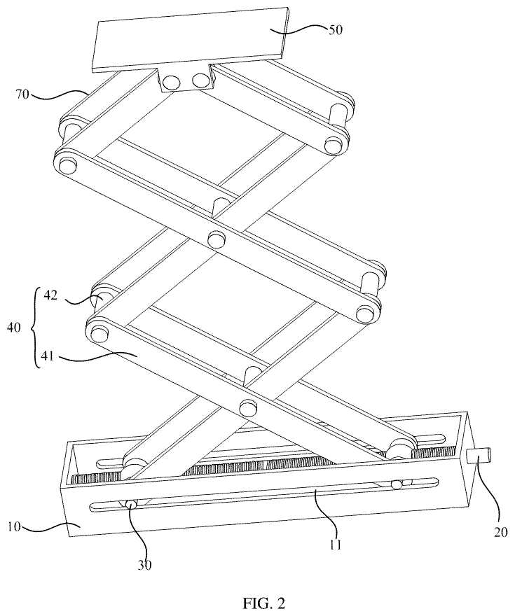

Based on this, the number of groups of the first telescopic unit 70 and the second telescopic unit 40 is increased to push objects of greater mass and increase the stability of the pushing process. FIG. 2 is an embodiment of the present application. Two groups of first telescopic unit 70 and second telescopic unit 40 are provided side by side along the axial direction of lead screw nut 30 and connected to each other through connecting shaft 42. Compared with FIG. 1, the connecting shaft 42 in FIG. 2 is longer. Both ends of the connecting shaft 42 are screw rod structures, and the middle part is a smooth connecting rod, which plays the role as the rotating shaft and the connection. The lower ends of the two groups of the second telescopic units 40 are connected to the lead screw nut 30, and the shearing movement is performed under the drive of the lead screw nut 30 to realize the telescopic function. The embodiment shown in FIG. 2 is more compact in structure, has more sufficient thrust, and has a more stable pushing effect.

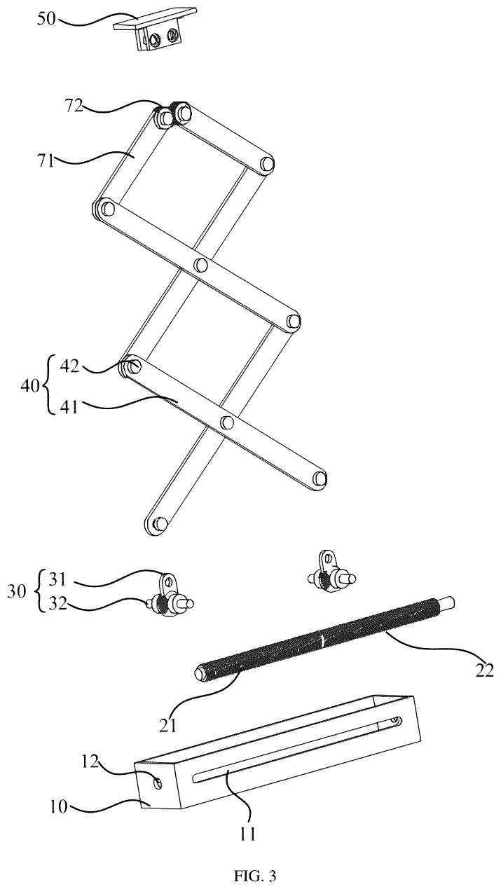

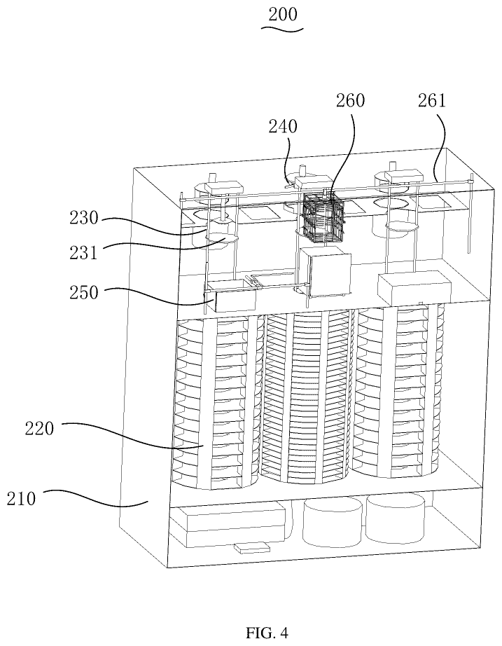

With reference to FIG. 3 and FIG. 4, in an embodiment, the lead screw nut 30 also includes a sliding rod 32 and/or a connecting portion 31, and the sliding rod 32 can be slidably penetrated in the guiding groove 11. The end of the second telescopic unit 40 can be hinged to the connecting portion 31 or rotatably connected to the sliding rod 32 of the lead screw nut 30.

For the second telescopic unit 40 with a single support, a connecting portion 31 is provided on the top of the lead screw nut 30, and a through hole is opened on the connecting portion 31 to connect with the second telescopic unit 40, so as to fix the second telescopic unit 40 and the lead screw nut 30, and facilitate installation and debugging. The connecting portion 31 and the lead screw nut 30 are rigidly connected, which can be integrally formed during production, or welded together after being produced separately. In other embodiments, the connecting portion 31 can be eliminated, and the end of the second telescopic unit 40 can be sleeved on the end of the lead screw nut 30, so as to achieve the connection between the lead screw nut 30 and the second telescopic unit 40; or according to the use of the second telescopic unit 40, a corresponding number of connecting portions 31 are provided along the axial direction of the lead screw nut 30.

In an embodiment, the shape of the end of the telescopic apparatus head 50 away from the base seat 10 is flat or bent.

Combined with FIG. 3, in this embodiment, the upper end of the telescopic apparatus head 50 is a flat table, and the lower end is two support plates. The telescopic apparatus head 50 is provided with a through hole to facilitate connection with the first telescopic unit 70. The shape of the end of the telescopic apparatus head 50 away from the base seat 10 has many possibilities. When the usage scenario is a narrow space and a small object is pushed, the end can be designed as a relatively small flat plate as in this solution; when the usage scenario is a relatively open space and a relatively large object is pushed, the end can be designed as a relatively large flat plate, a shovel shape, a crescent shape, a hook shape or a gripper shape; when a cylindrical object is pushed, the end can be in an arc surface shape. According to different usage scenarios and usage requirements, the shape of the end has many changes and is highly adaptable.

The present application also provides an automatic food vending machine 200, which includes a machine shell 210, a food storage rack 220 and a food collection assembly 230. The machine shell 210 is enclosed to form an accommodation chamber, and a food delivery port is opened in the machine shell 210. The food storage rack 220 is provided in the accommodation chamber and has a plurality of storage spaces. The food collection assembly 230 includes a food storage member 231 and a food pushing member. The food storage member 231 is movably provided in the food storage rack 220, and the food pushing member is movably provided on a peripheral side of the food storage rack 220, so as to push the food in the storage space to the food storage member 231 or the food delivery port. The telescopic apparatus of the food pushing member is the scissor-type telescopic apparatus 100 as described above.

With reference to FIG. 4, the machine shell 210 of the automatic food vending machine 200 provides the accommodation space and protection for various components inside. The food storage rack 220 is provided in the middle and lower part of the machine shell 210 for storing food to be sold. The multiple storage spaces facilitate the placement and separation of food. The food collection assembly 230 is provided on the upper part of the food storage rack 220. The selected food is taken out from the food storage rack 220, placed on the food storage member 231, and is pushed by the food pushing member. The telescopic apparatus of the food pushing member is any of the above scissor-type telescopic apparatus 100. Since the automatic food vending machine 200 adopts all the technical solutions of all the above scissor-type telescopic apparatus 100, it at least has all the beneficial effects brought by the technical solutions of the above scissor-type telescopic apparatus 100, which will not be repeated here.

In an embodiment, the automatic food vending machine 200 further includes a heating component 240, a food delivery box 250 and a food delivery transfer apparatus 260. The heating component 240 is provided above the food storage rack 220; the food delivery box 250 is adjacent to the food delivery port; and the food delivery transfer apparatus 260 is movably provided between the heating component 240 and the food delivery box 250.

The heating component 240 is provided above the food collection assembly 230, and is configured to heat the food to be sold to meet the customer's requirements for the food temperature. The food pushing member is configured to push the food to the food delivery box 250, and the food is delivered to the food delivery box 250 via the food delivery transfer apparatus 260. The structure of the heating component 240 is different according to different kinds of food. For example, the heating component 240 can be heated by baking, water bath, steam, etc., so as to further improve the taste of the food and the user's experience of freshly made and sold food. In this embodiment, the telescopic apparatus of the food pushing member is the scissor-type telescopic apparatus 100, which has a small installation space and a large telescopic distance. The scissor-type telescopic apparatus 100 used in the food pushing member can also be used in other places where pushing or stretching is required, which is not limited here. According to the shape of the food sold, the overall structure of the food delivery transfer apparatus 260 can be a cube, a rectangular cuboid, a cylinder, or a polygonal prism, etc.

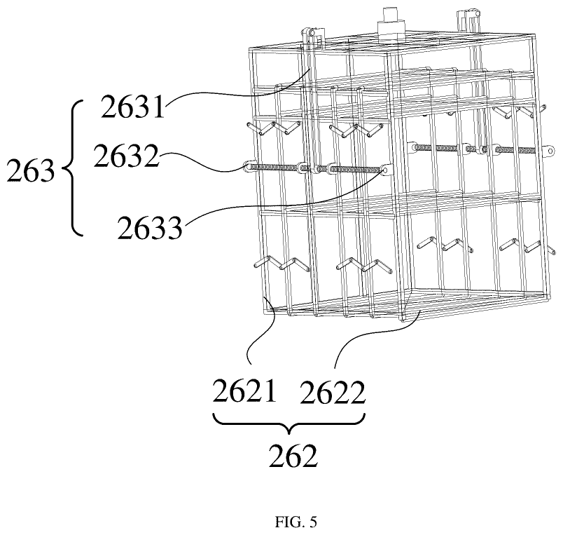

With reference to FIG. 5, in an embodiment, the food delivery transfer apparatus 260 includes a bracket 261 and a lifting box 262, and the lifting box 262 includes a frame body 2621 and a movable bottom plate 2622. The frame body 2621 and the movable bottom plate 2622 are enclosed to form a storage chamber. One side of the frame body 2621 is a fixed opening configured to allow food of the food collection assembly 230 to enter the storage chamber, and the movable bottom plate 2622 can be movably connected to the bottom surface of the frame body 2621 to open or close the bottom surface of the lifting box 262.

In this embodiment, the bracket 261 is configured to support the lifting box 262. The bracket 261 is connected to the machine shell 210, and the lifting box 262 is specifically provided between the food collection assembly 230 and the food delivery box 250 and is configured to receive the food and deliver it into the food delivery box 250. The lifting box 262 includes a frame body 2621 and a movable bottom plate 2622. The frame body 2621 is substantially in the shape of a rectangular cuboid or a cube and has six surfaces. The movable bottom plate 2622 is movably provided on the surface of the frame body 2621. The frame body 2621 and the movable bottom plate 2622 are enclosed to form the storage chamber. The storage chamber is provided with a fixed opening, which faces the food storage member 231 of the food collection assembly 230 and is configured to receive food. Meanwhile, the bracket 261 can be movably connected to the machine shell 210, and the bracket 261 can drive the lifting box 262 to rise and fall, so that the lifting box 262 can move in the plane where the food collection assembly 230 is provided and the food delivery box 250. In this way, a sensor is provided at the lifting box 262. When it is detected that food is put into the storage chamber, the lifting box 262 is first moved downward to the food delivery space, and the movable bottom plate 2622 is driven to open the bottom surface of the frame body 2621, so that the food falls into the food delivery space. In this way, the lifting box 262 can control the movable bottom plate 2622 to open the bottom surface of the frame body 2621 after entering the food delivery space, so that the food does not fall from a high place when serving, effectively ensuring the integrity of the food and improving the purchasing experience. In addition, the structure can take on multiple foods at one time to achieve fast serving of multiple food.

In an embodiment, the food delivery transfer apparatus 260 further includes a driving assembly 263, and the driving assembly 263 includes a driving member 2631, a transmission member 2633 and a lead screw slider 2632. The transmission member 2633 drives the side rods on both sides of the lifting box 262 to move in opposite directions respectively, thereby driving the bottom rod of the movable bottom plate 2622 to move in opposite directions to open or close the bottom surface of the lifting box 262.

In this embodiment, for convenience of control, the driving assembly 263 is provided on the lifting box 262, and the driving member 2631 in the driving assembly 263 is configured to drive the movable bottom plate 2622 to move. The power source of the driving member 2631 can be a motor or a cylinder, etc., which is not limited here. The side rods connected to the movable bottom plate 2622 are symmetrically provided along the central axis of the lifting box 262, and a transmission member 2633 is provided in the middle of the side rods. The transmission member 2633 in this embodiment uses the bidirectional lead screw 20, which has a simple structure and a good transmission effect. The lead screw slider 2632 is sleeved on the transmission member 2633. Under the action of the driving member 2631, the transmission member 2633 rotates in one direction, driving the two lead screw sliders 2632 to move in opposite direction, thereby driving the side rods on both sides of the central axis to move in opposite direction. At this time, a part of the movable bottom plate 2622 moves towards one side of the frame body 2621, and the other part of the movable bottom plate 2622 moves towards the other side of the frame body 2621, so as to open or close the bottom surface of the frame body 2621. The transmission rotating shaft in this embodiment is provided in the middle of the transmission member 2633, and in other embodiments, the transmission rotating shaft can be provided at one end of the lead screw.

The above embodiments are only part of the present application and do not therefore limit the scope of the present application. Any equivalent structure or equivalent process transformation made by using the contents and drawings of the present application under the inventive concept of the present application, or directly or indirectly used in other relevant technical fields, are included in the scope of the present application.

What is claimed is:

1. A scissor-type telescopic apparatus, comprising:
a base seat;
a bidirectional lead screw comprising a right-hand thread portion and a left-hand thread portion, wherein two ends of the bidirectional lead screw are rotatably connected to opposite two sides of the base seat;
two lead screw nuts respectively threaded with the right-hand thread portion and the left-hand thread portion of the bidirectional lead screw, so as to move relatively away or relatively close in response to that the bidirectional lead screw is rotated;
a first telescopic unit comprising two first scissor arms, wherein ends of the two first scissor arms away from the base seat are both provided with gears, and the two gears are meshed; and
a telescopic apparatus head respectively hinged with the ends of the two first scissor arms away from the base seat, so as to drive the telescopic apparatus head to move close to or away from the base seat in response to that the telescopic unit is extended or retracted.

2. The scissor-type telescopic apparatus according to claim 1, wherein the base seat is enclosed to form an accommodation groove, and two opposite side walls of the accommodation groove are provided with shaft holes;
the ends of the bidirectional lead screws are rotatably inserted into the shaft holes, and the other two opposite side walls of the accommodation groove are provided with guiding grooves, and
two ends of the two lead screw nuts are respectively slidably inserted into the two guiding grooves.

3. The scissor-type telescopic apparatus according to claim 2, further comprising:
a second telescopic unit;
wherein the second telescopic unit comprises two second scissor arms, and middle parts of the two second scissor arms are hinged to form an X-shaped scissor structure; and
two ends of the two second scissor arms close to the base seat are respectively hinged to the two lead screw nuts.

4. The scissor-type telescopic apparatus according to claim 3, wherein one, two or more second telescopic units are provided, and the two or more scissor arms of the second telescopic units are hinged in sequence in a telescopic direction of the scissor-type telescopic apparatus; and
two ends of the first telescopic unit on one side close to the base seat are respectively hinged with two ends of the second telescopic unit farthest from the base seat on one side away from the base seat.

5. The scissor-type telescopic apparatus according to claim 3, wherein one, two or more groups of the first telescopic units and the second telescopic units are provided, and the two or more groups of the first telescopic units and the second telescopic units are provided in parallel and spaced apart.

6. The scissor-type telescopic apparatus according to claim 3, wherein the lead screw nut further comprises a sliding rod slidably provided in the guiding groove.

7. The scissor-type telescopic apparatus according to claim 6, wherein the lead screw nut further comprises a connecting portion, and an end of the second telescopic unit is hinged to the connecting portion or rotatably connected to the sliding rod of the lead screw nut.

8. The scissor-type telescopic apparatus according to claim 1, wherein a shape of one end of the telescopic apparatus head away from the base seat is flat or bent.

9. An automatic food vending machine, comprising:
a machine shell enclosed to form an accommodation chamber and provided with a food delivery port;
a food storage rack provided in the accommodation chamber and provided with a plurality of storage spaces; and
a food collection assembly comprising a food storage member and a food pushing member, wherein the food storage member is movably provided in the food storage rack, and the food pushing member is movably provided on a periphery side of the food storage rack to push the food in the storage space to the food storage member or the food delivery port;
wherein a telescopic apparatus of the food pushing member is the scissor-type telescopic apparatus according to claim 1.

10. The automatic food vending machine according to claim 9, further comprising:
a heating component;
a food delivery box; and
a food delivery transfer apparatus;
wherein the heating component is provided above the food storage rack;
the food delivery box is adjacent to the food delivery port; and
the food delivery transfer apparatus is movably provided between the heating component and the food delivery box.

11. The automatic food vending machine according to claim 10, wherein the food delivery transfer apparatus comprises a bracket and a lifting box, and the lifting box comprises a frame body and a movable bottom plate;
the frame body and the movable bottom plate are enclosed to form a storage chamber, and one side of the frame body is a fixed opening configured to allow the food of the food collection assembly to enter the storage chamber; and
the movable bottom plate is movably connected to a bottom surface of the frame body to open or close the bottom surface of the lifting box.

12. The automatic food vending machine according to claim 11, wherein the food delivery transfer apparatus further comprises a driving assembly, and the driving assembly comprises a driving member a bidirectional lead screw and a lead screw slider; and
the bidirectional lead screw is configured to drive side rods on both sides of the lifting box to move in opposite directions, so as to drive a bottom rod of the movable bottom plate to move in opposite directions to open or close the bottom surface of the lifting box.
